(19) United States
(12) Patent Application Publication
(10) Pub. No.: US 2026/0166880 A1
(43) Pub. Date: Jun. 18, 2026

(54) LIQUID EJECTION HEAD, LIQUID EJECTION HEAD SUBSTRATE, AND MANUFACTURING METHOD OF LIQUID EJECTION HEAD

(71) Applicant: CANON KABUSHIKI KAISHA, Tokyo (JP)

(72) Inventors: KEIJI MATSUMOTO, Kanagawa (JP); MASAFUMI MORISUE, Tokyo (JP)

(21) Appl. No.: 19/423,117

(22) Filed: Dec. 17, 2025

(30) Foreign Application Priority Data
Dec. 18, 2024 (JP) 2024-222371

(51) Int. Cl. B41J 2/14; B41J 2/16

(52) U.S. Cl. CPC B41J 2/1433; B41J 2/14032; B41J 2/14145; B41J 2/162; B41J 2/1631; B41J 2002/14411; B41J 2002/14419; B41J 2202/11

(57) ABSTRACT

A liquid ejection head includes: a liquid flow passage through which a liquid can flow; ejection ports communicating with the liquid flow passage and capable of ejecting the liquid; an ejection port array in which the ejection ports are aligned; energy generation elements opposed to the ejection ports and configured to generate energy for ejecting the liquid in the liquid flow passage from the ejection ports; and a substrate provided with the energy generation elements, a flow passage wall-forming layer in which the liquid flow passage is formed is formed on the substrate, an ejection port-forming layer in which the ejection port array is formed is formed on the flow passage wall-forming layer, and a liquid ejection head includes a groove provided in the ejection port-forming layer along the ejection port array and having a bottom portion formed of the ejection port-forming layer or the flow passage wall-forming layer.

### BACKGROUND

### Field of the Technology

The present disclosure relates to a liquid ejection head, a liquid ejection head substrate, and a manufacturing method of the liquid ejection head.

### Description of the Related Art

Japanese Patent Laid-Open No. 2009-196355 discloses a liquid ejection head in which hole portions for disrupting an effect of stress on ejection ports are provided around an ejection port array. Providing the hole portions that disrupt stress reduces stress partially applied to an ejection port plate, and suppresses peeling of the ejection port plate from a substrate. The depth of the hole portions includes ejection ports and a portion of a flow passage configured to supply a liquid to the ejection ports, and reaches the substrate, and the hole portions have structures with large volumes. Moreover, the hole portions have opening areas larger than the opening areas of the ejection ports.

In the case of a hole portion having a structure with a large opening area and a large volume as described above, ejected liquid and liquid attached to an ejection port face on which ejection ports are formed sometimes accumulate in an opening portion of the hole portion.

### SUMMARY

The liquid accumulated in the hole portions with large volumes overflows from the hole portions in printing, and reaches the ejection ports in some cases. In the case where the liquid overflowing from the hole portions reaches the ejection ports, there is a possibility that the liquid affects printing and causes printing quality to decrease.

Accordingly, the present disclosure provides a technique that can suppress a decrease of printing quality.

To this end, a liquid ejection head of the present disclosure includes: a liquid flow passage through which a liquid is capable of flowing; a plurality of ejection ports communicating with the liquid flow passage and capable of ejecting the liquid; an ejection port array in which the plurality of ejection ports are aligned; a plurality of energy generation elements provided to be opposed to the ejection ports and configured to generate energy for ejecting the liquid in the liquid flow passage from the ejection ports; and a substrate provided with the energy generation elements, a flow passage wall-forming layer in which the liquid flow passage is formed is formed on the substrate, an ejection port-forming layer in which the ejection port array is formed is formed on the flow passage wall-forming layer, and a liquid ejection head includes a groove that is provided in the ejection port-forming layer along the ejection port array and that has a bottom portion formed of the ejection port-forming layer or the flow passage wall-forming layer.

According to the present disclosure, the liquid ejection head can provide a technique that can suppress a decrease of printing quality.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic perspective diagram illustrating an example of a liquid ejection head substrate;

FIG. 2 is a diagram illustrating a cross-section along II-II in FIG. 1;

FIG. 3A is a cross-sectional diagram illustrating a manufacturing step of the liquid ejection head substrate in sequence;

FIG. 3B is a cross-sectional diagram illustrating a manufacturing step of the liquid ejection head substrate in sequence;

FIG. 3C is a cross-sectional diagram illustrating a manufacturing step of the liquid ejection head substrate in sequence;

FIG. 3D is a cross-sectional diagram illustrating a manufacturing step of the liquid ejection head substrate in sequence;

FIG. 3E is a cross-sectional diagram illustrating a manufacturing step of the liquid ejection head substrate in sequence;

FIG. 3F is a cross-sectional diagram illustrating a manufacturing step of the liquid ejection head substrate in sequence;

FIG. 4 is a diagram illustrating part of an ejection port array and stress disrupting grooves of the liquid ejection head substrate;

FIG. 5 is a cross-sectional diagram along V-V in FIG. 4;

FIG. 6 is a diagram illustrating part of the ejection port array and the stress disrupting grooves of the liquid ejection head substrate;

FIG. 7 is a diagram illustrating part of the ejection port array and the stress disrupting grooves of the liquid ejection head substrate; and

FIG. 8 is a diagram illustrating part of the ejection port array and the stress disrupting grooves of the liquid ejection head substrate.

### DESCRIPTION OF THE EMBODIMENTS

### First Embodiment

A first embodiment of the present disclosure is explained below with reference to the drawings.

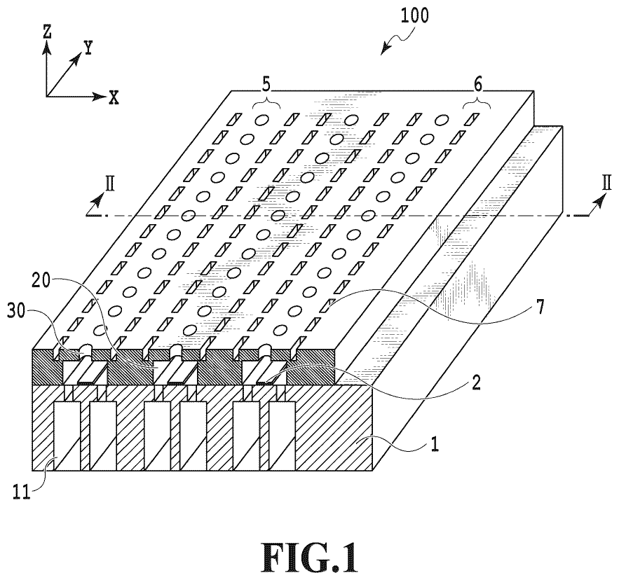

FIG. 1 is a schematic perspective diagram illustrating an example of a liquid ejection head substrate 100 in the present embodiment. The liquid ejection head substrate 100 illustrated in FIG. 1 includes a substrate 1 on which ejection energy generation elements 2 are arranged to be aligned in a Y direction at a predetermined pitch. Liquid flow passages 20 and ejection ports 30 arranged in a Z direction with respect to the ejection energy generation elements 2 are formed in the substrate 1. The ejection ports 30 are provided to be opposed to the ejection energy generation elements 2, and are configured to be capable of ejecting a liquid in the liquid flow passages by an action of the ejection energy generation elements 2. Moreover, liquid supply ports 11 are formed in the substrate 1 on both sides of the ejection energy generation elements 2. Multiple ejection port arrays 5 including the ejection energy generation elements 2 and the liquid supply ports 11 are arranged in the X direction.

Stress disrupting grooves 6 are provided to correspond to the ejection port arrays 5, and are provided along the ejection port arrays 5. In the present embodiment, one array of the stress disrupting grooves 6 is provided on each side of each ejection port array 5. In each stress disrupting groove 6, multiple groove portions 7 are provided to be aligned in the Y direction, and are aligned over at least a length equal to or longer than the length of the ejection port array 5 in the Y direction. The stress disrupting grooves 6 are parallel to the ejection port arrays 5, do not communicate with the liquid flow passages 20, and are formed to have the same opening plane as the ejection ports 30. In the case where the ejection energy generation elements 2 apply pressure to the liquid filled from the liquid supply ports 11 into the liquid flow passages 20, liquid droplets are ejected from the ejection ports 30. The ejected liquid droplets attach to a print medium, and printing is thereby performed.

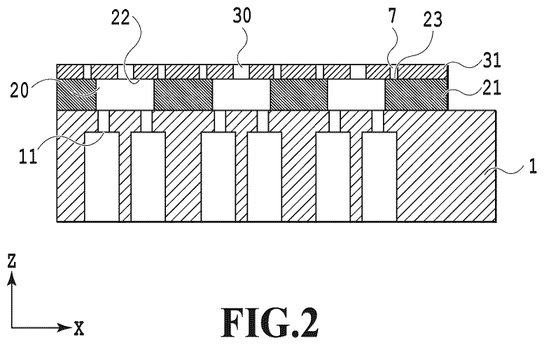

FIG. 2 is a diagram illustrating a cross-section along II-II in FIG. 1. In the liquid ejection head substrate 100, multiple ejection energy generation elements 2 (see FIG. 1) are arranged on the substrate 1, and an insulating protection film (not illustrated) is formed on the ejection energy generation elements 2. Moreover, the liquid supply ports 11 that supply the liquid to the ejection ports 30 are formed in the substrate 1. Flow passage walls defining the liquid flow passages 20 are formed by a flow passage wall-forming layer 21, and the ejection ports 30, a flow passage ceiling 22, and groove portions 7 forming stress disrupting groove arrays are formed by an ejection port-forming layer 31.

In this case, the insulating protection film is patterned by photolithography, dry etching, or the like to match openings of the liquid supply ports 11, and the liquid supply ports 11 communicate with the liquid flow passages 20 and the ejection ports 30. Moreover, the groove portions 7 of the stress disrupting grooves 6 (see FIG. 1) are provided to penetrate the ejection port-forming layer 31, do not communicate with the liquid flow passages 20, and are opened on the same plane as the plane on which the ejection ports 30 are opened. The groove portions 7 include bottom faces 23 formed by the flow passage wall-forming layer 21. Providing the groove portions 7 in the ejection port-forming layer 31 can distribute and reduce stress in a bonding portion between the flow passage wall-forming layer 21 and the ejection port-forming layer 31. As a result, deformation of the ejection ports 30 can be suppressed.

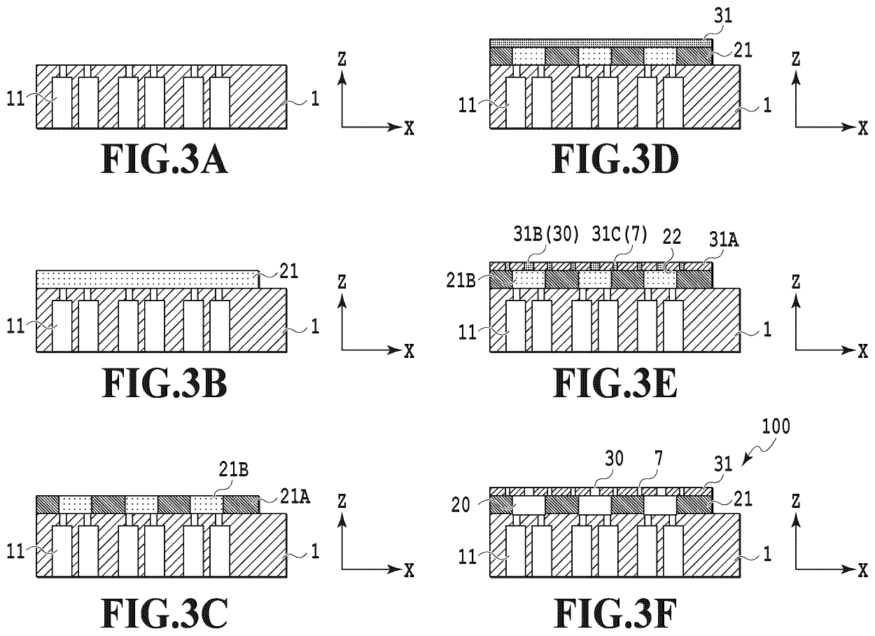

FIGS. 3A to 3F are cross-sectional diagrams illustrating manufacturing steps of the liquid ejection head substrate 100 in sequence. A manufacturing method of the liquid ejection head substrate 100 is explained below by using FIGS. 3A to 3F.

As illustrated in FIG. 3A, multiple ejection energy generation elements 2 (see FIG. 1) are arranged on the substrate 1, and the insulating protection film (not illustrated) is formed on the ejection energy generation elements 2. The substrate 1 is not limited to a particular substrate as long as it is a material usable as a semiconductor element substrate such as silicon. A material of the ejection energy generation elements 2 is a resistor such as TaSiN, and is not limited to a particular material as long as the ejection energy generation elements 2 can heat the liquid in response to an electric signal and apply ejection energy to the liquid. The material of the insulating protection film is an insulating film such as SiN, SiC, or SiO, and is not limited to a particular material as long as it can protect electric wiring from an ink and other liquids. Moreover, in the substrate 1, the liquid supply ports 11 that penetrate the substrate 1 are formed by dry etching or the like. The liquid supply ports 11 only need to penetrate the substrate 1, and processing method thereof is not limited to a particular method.

As illustrated in FIG. 3B, the flow passage wall-forming layer 21 fixed to a not-illustrated supporting member is transferred to the substrate 1 (flow passage wall-forming layer forming step). A dry film resist is used for the flow passage wall-forming layer 21, and the supporting member is not limited to a particular material as long as it is a material stable to thermal history of the flow passage wall-forming layer 21 such as polyethylene terephthalate or polyimide. Moreover, the material of the flow passage wall-forming layer 21 is preferably a negative photosensitive resin. Examples of the negative photosensitive resin used for the flow passage wall-forming layer 21 include a cresol novolac resin, an epoxy resin, and the like.

Temperature and pressure in the transfer only needs to be temperature and pressure at which: the flow passage wall-forming layer 21 softens; a step on a surface of the substrate 1 can be covered; and the resin is not altered. For example, 60° C. or more and 140° C. or less and 0.1 MPa or more and 1.5 MPa or less can be used as the temperature and the pressure. Then, the supporting member is peeled off from the flow passage wall-forming layer 21, and only the flow passage wall-forming layer 21 stays on the substrate.

As illustrated in FIG. 3C, a portion desired to stay as a permanent film in the flow passage wall-forming layer 21 is selectively exposed to light through a photomask, and heat treatment after the exposure (hereinafter, referred to as PEB) is performed to optically determine a cured portion 21A and an uncured portion 21B. In the present embodiment, since the embodiment using the negative photosensitive resin is described, the portion exposed to light is the cured portion, the cured portion 21A is the flow passage walls, and the uncured portion 21B is the liquid flow passages.

As illustrated in FIG. 3D, the ejection port-forming layer 31 fixed to a not-illustrated supporting member is transferred onto the flow passage wall-forming layer (ejection port-forming layer forming step). A dry film resist is used for the ejection port-forming layer 31, and the supporting member is not limited to a particular material as long as it is a material stable to thermal history of the ejection port-forming layer such as polyethylene terephthalate or polyimide. Moreover, the material of the ejection port-forming layer 31 is preferably a negative photosensitive resin. Examples of the negative photosensitive resin used for the ejection port-forming layer 31 include a cresol novolac resin, an epoxy resin, and the like.

Temperature and pressure in the transfer only needs to be temperature and pressure at which the ejection port-forming layer 31 can be transferred and the already-formed flow passage wall-forming layer 21 does not deform. For example, 30° C. or more and 50° C. or less and 0.1 MPa or more and 0.5 MPa or less can be used as the temperature and the pressure. Then, the supporting member is peeled off from the ejection port-forming layer 31, and only the ejection port-forming layer 31 stay on the flow passage wall-forming layer 21.

As illustrated in FIG. 3D, a portion of the ejection port-forming layer 31 desired to stay as a permanent film is selectively exposed to light through a photomask, and PEF after the exposure is performed to optically determine a cured portion 31A and uncured portions 31B and 31C. In the present embodiment, since the embodiment using the negative photosensitive resin is described, the portion exposed to light is the cured portion, the cured portion 31A is the flow passage ceiling 22, the uncured portion 31B is the ejection ports 30, and the uncured portion 31C is the groove portions 7. In this case, a material more sensitive to light than the material used for the flow passage wall-forming layer 21 is desirably used as the material for the ejection port-forming layer 31. This allows only the ejection port-forming layer 31 to be selectively patterned.

As illustrated in FIG. 3F, the uncured portions of the flow passage wall-forming layer 21 and the ejection port-forming layer 31 are dissolved and removed with a liquid capable of dissolving the uncured portions, and development is performed. Removing the uncured portions with a solvent capable of dissolving the uncured portions in this step forms the liquid flow passages 20, the ejection ports 30, and the groove portions 7 (groove formation step). As described above, the formation of the ejection ports 30 and the formation of the groove portions 7 are simultaneously performed.

The liquid ejection head substrate 100 that ejects the liquid flowing in from the liquid supply ports 11 from the ejection ports 30 and that includes the groove portions 7 having a stress disruption effect in the ejection port-forming layer 31 is completed through the above-mentioned steps. Then, the liquid ejection head substrate 100 is cut and divided by a dicing saw or the like to form chips. Next, electric wiring for driving the ejection energy generation elements 2 (see FIG. 1) is bonded to each chip, and then a chip tank member for liquid supply is bonded to the chip. A liquid ejection head including the liquid ejection head substrate 100 is thereby completed.

Note that, although each stress disrupting groove 6 is formed of multiple groove portions 7 in the present embodiment, the stress disrupting groove 6 only needs to disrupt the stress, and it is only necessary that at least one groove is formed in the ejection port-forming layer 31. Note that, from the viewpoint of the volume of the groove portions 7, the stress disrupting groove 6 is desirably formed of multiple groove portions 7. Moreover, although the groove portions 7 are formed to penetrate the ejection port-forming layer 31 in the present embodiment, bottom faces of the groove portions 7 may be formed inside the ejection port-forming layer 31, or formed on the surface of the flow passage wall-forming layer 21 or inside the flow passage wall-forming layer 21. In other words, the bottom faces of the groove portions 7 are not limited to a particular configuration as long as the bottom faces do not reach the substrate 1. Accordingly, the bottom faces of the groove portions 7 are formed by the ejection port-forming layer 31 or the flow passage wall-forming layer 21.

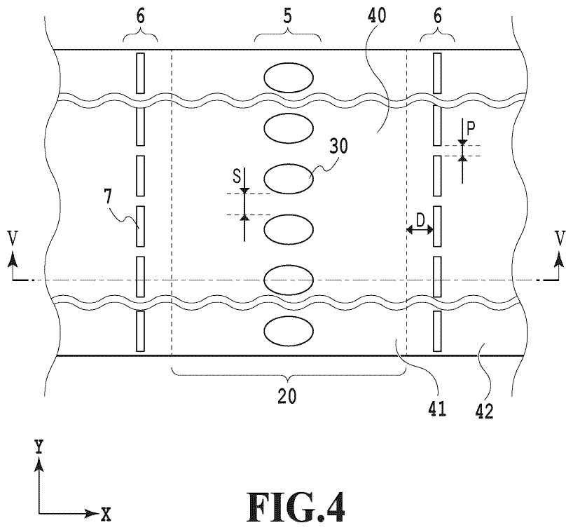

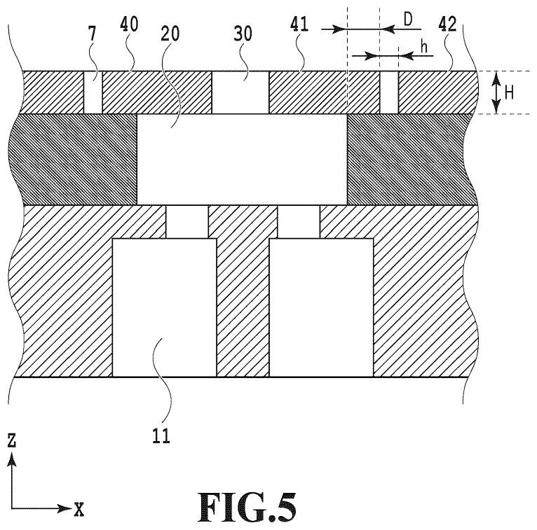

FIG. 4 is a diagram illustrating part of the ejection port array 5 and the stress disrupting grooves (groove portion arrays) 6 of the liquid ejection head substrate 100 in the present embodiment, and FIG. 5 is a cross-sectional diagram along V-V in FIG. 4. Preferrable arrangement of the groove portions 7 is explained below by using FIGS. 4 and 5. As illustrated in FIGS. 4 and 5, the width h of the groove portions 7 in the X direction is preferably small to hinder entrance of the liquid, and is preferably set within a range of h=H/2 to 5H, where H is the thickness of the ejection port-forming layer 31. In the present embodiment, the width h is assumed to within a range of 3 μm to 25 μm. Note that the magnitude of the width of the groove portions 7 in the X direction is confirmed to hardly affect the stress disruption effect. Accordingly, the width of the groove portions 7 in the X direction is desirably made as small as possible within a range in which processing is possible to hinder the entrance of the liquid. Moreover, the distance D between each groove portion 7 and the liquid flow passage 20 is desirably 20 μm or less from a viewpoint of the stress disruption effect. The stress disruption effect can be checked by checking a degree of deformation of the ejection ports 30 caused by shrinkage of the ejection port-forming layer 31. Moreover, the distance D can be translated as a distance from a wall of the liquid flow passage 20 having a face including the ejection direction on one side of the ejection port array 5 to a wall of the groove portion 7 having a face including the ejection direction on the side close to the ejection ports, in a direction orthogonal to the ejection port array 5 in the same plane as the ejection port array 5. Moreover, it is confirmed that the smaller the distance D is, the less the effect of the stress on the ejection ports 30 is.

As described above, the stress disrupting grooves 6 divide the ejection port-forming layer 31 into first regions 41 in which the ejection port arrays 5 are provided and second regions 42 that are separated from the first regions 41 to reduce the volume of the continuous ejection port-forming layer 31 in which ejection port arrays 5 are provided. This division reduces the volume of the ejection port-forming layer 31 in each of the regions, and can reduce the effect of the stress on the ejection ports 30. Note that, although the stress disrupting grooves 6 are explained to divide the ejection port-forming layer 31 into the first regions 41 and the second regions 42 in this description, the ejection port-forming layer 31 does not have to be divided into the first regions 41 and the second regions 42, and it is only necessary that free ends are formed in the ejection port-forming layer 31 by the stress disrupting grooves 6 to allow distribution of stress.

Moreover, assuming that a distance between ejection ports adjacent to each other in the ejection port arrays 5 is distance (interval) S, there is such a tendency that the smaller the distance S is, the more likely the effect of the stress is to become apparent. Specifically, deformation around the ejection ports caused by the stress is slightly large in the case where the distance S is 25 μm or less, and is even larger in the case where the distance S is 10 μm or less. However, the distance S is a value that directly affects printing quality, and cannot be set while taking only the effect of the stress into consideration. Accordingly, the distance S may be 25 μm or less, or 10 μm or less.

Moreover, assuming that an inter-groove distance between the groove portions 7 adjacent to each other in the stress disrupting grooves 6 is distance P, the distance P is preferably 10 μm or less from the viewpoint of the stress disruption effect. In the case where the inter-groove distance P is larger than 10 μm, a portion where the stress disruption effect is relatively large and a portion where the stress disruption effect is relatively small tend to be formed in the ejection port arrays. In view of this, it is desirable to set the distance P that is the inter-groove distance to 10 μm or less while setting the opening area of the groove portions 7 to a small opening area and setting the volume of the groove portions 7 to a small volume.

### Example

An example in the present embodiment is explained below with reference to FIGS. 3A to 3F again.

As illustrated in FIG. 3A, the multiple ejection energy generation elements 2 (see FIG. 1) were arranged on the substrate 1, and the insulating protection film (not illustrated) was formed on the ejection energy generation elements 2. A silicon substrate was used as the substrate 1, and TaSiN was used as the heat generating resistor. Moreover, a film of SiO and SiN was formed by plasma CVD as the insulating protection film. Thereafter, a mask resist was formed on the insulating protection film to perform patterning, and then the substrate 1 was processed by dry etching to form the liquid supply ports 11.

As illustrated in FIG. 3B, an object that was obtained by forming the flow passage wall-forming layer 21 being the negative photosensitive resin into a dry film form on the not-illustrated supporting member was formed on the insulating protection film (not illustrated) at a thickness of 15 μm. A PET film subjected to a release process was used as the supporting member of the dry film resist. The temperature of transfer was 70° C., and the pressure of transfer was 0.5 MPa. Peeling of the supporting member was performed at a rate of 5 mm/s.

As illustrated in FIG. 3C, portions of the flow passage wall-forming layer 21 to be flow passage side walls later were exposed to an i-ray (wavelength of 365 nm) through the photomask, and then PEB was performed to promote curing reaction.

As illustrated in FIG. 3D, the ejection port-forming layer 31 formed of a dry film form negative photosensitive resin was formed on the flow passage wall-forming layer 21 at a thickness of 6 μm. A PET film subjected to a release process was used as a supporting member of the dry film resist. The temperature at which the ejection port-forming layer was transferred was 40° C., and the pressure at which the ejection port-forming layer was transferred was 0.3 MPa. Peeling of the supporting member was performed at a rate of 5 mm/s.

As illustrated in FIG. 3E, a portion of the ejection port-forming layer 31 to be the flow passage ceiling 22 later was exposed to an i-ray (wavelength of 365 nm), and the cured portion 31A to be the flow passage ceiling 22, the uncured portion 31B to be the ejection ports 30, and the uncured portion 31C to be the groove portions 7 were optically determined. In this case, although the uncured portion 21B of the flow passage wall-forming layer 21 was also irradiated with light, since an exposure dose at which only the ejection port-forming layer 31 was cured was selected, no curing reaction occurred in the uncured portion 21B. Then, heating was performed for 5 minutes at 90° C. as PEB by using a hot plate, and curing reaction was promoted.

As illustrated in FIG. 3F, the uncured portions of the flow passage wall-forming layer 21 and the ejection port-forming layer 31 were removed simultaneously in a development process, and the liquid flow passages 20, the ejection ports 30, and the groove portions 7 were formed. The development process was performed for 15 minutes with propylene glycol monomethyl acetate used as a solvent capable of dissolving the unexposed portions. A high-quality ejection characteristic was confirmed as a result of performing printing with a liquid ejection head completed through the above-mentioned steps.

Study of liquid ejection heads was performed while setting various conditions for the distance S, the distance D, and the distance P. Note that a condition where the distance S was 10 μm or less, the distance D was 20 μm or less, and the distance P was 10 μm or less was assumed to be a preferable condition.

First, the case where the distance S between the ejection ports was 10 μm, the distance D from each groove portion 7 to the liquid flow passage 20 was 10 μm, and the inter-groove distance P was 20 μm was studied. Although the stress disruption effect of the groove portions 7 was present, since the inter-groove distance P was large, the stress disruption effect varies between portions with the grooves and portions without the grooves, and there was distribution in in-array stress of ejection port portions important for high-quality printing. Accordingly, a stress concentrated portion was formed, and variation in an ejection port shape occurred. As a result of performing printing with this liquid ejection head, it was confirmed that high-quality printing was performed but the ejection characteristic was poorer than that in the preferable condition.

Moreover, the case where the distance S between the ejection ports was 10 μm, the distance D from each groove portion 7 to the liquid flow passage 20 was 30 μm, and the inter-groove distance P was 10 μm was studied. Since the inter-groove distance P was 10 μm or less, the in-array stress distribution of the ejection port portions did not occur. However, since the distance D from each groove portion 7 to the liquid flow passage 20 was 30 μm and was large, a liquid ejection head in which a desired stress disruption effect by the groove portions 7 could not be obtained was completed. As a result of performing printing with this liquid ejection head, it was confirmed that high-quality printing was performed but the ejection characteristic was poorer than that in the preferable condition. This liquid ejection head was observed, and occurrence of minor deformation of the ejection ports caused by the stress in the ejection port-forming layer was confirmed.

As described above, the liquid ejection head substrate 100 includes the groove portions 7 that are provided in the ejection port-forming layer 31 along the ejection port arrays 5 and that have the bottom portions formed of the ejection port-forming layer 31 or the flow passage wall-forming layer 21.

A technique that can suppress a decrease in printing quality can be thereby provided.

### Second Embodiment

A second embodiment of the present disclosure is exampled below with reference to the drawings. Note that, since a basic configuration of the present embodiment is the same as that of the first embodiment, characteristic configurations are explained below.

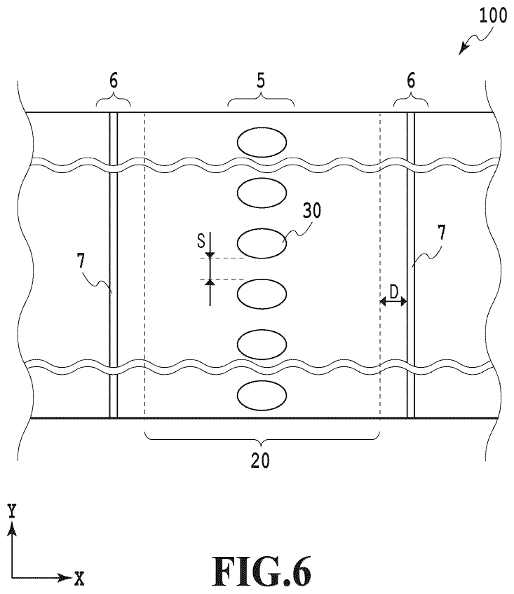

FIG. 6 is a diagram illustrating part of the ejection port array 5 and the stress disrupting grooves 6 of the liquid ejection head substrate 100 in the present embodiment. In the present embodiment, explanation is given of the liquid ejection head substrate 100 including groove portions 7 with an elongated hole shape provided to extend along the ejection port array 5.

Each of the groove portions 7 of the present embodiment is an uninterrupted continuous groove, and is provided to extend in the Y direction along the ejection port array 5. Since the multiple groove portions 7 are aligned in each of the stress disrupting grooves 6 in the first embodiment, there are the portions with grooves and the portions without grooves in the Y direction, and the stress disruption effect sometimes varies between the portion with grooves and the portions without grooves. Accordingly, in the present embodiment, the groove portions 7 are formed as one groove extending in the Y direction, and the portions without grooves are eliminated in the Y direction. Accordingly, a desired stress disruption effect is obtained, and no deformation of the ejection ports 30 is observed.

The groove portions 7 desirably extend over at least a length equal to or more than the length over which the ejection port arrays 5 extend. The width of the groove portions 7 in the X direction is the same as that in the first embodiment, and is preferably as small as possible as long as processing is possible to hinder entrance of the liquid. Note that the distance S and the distance D are the same as those in the first embodiment. A high-quality ejection characteristic is confirmed as a result of performing printing with a liquid ejection head completed as described above.

### Third Embodiment

A third embodiment of the present disclosure is exampled below with reference to the drawings. Note that, since a basic configuration of the present embodiment is the same as that of the first embodiment, characteristic configurations are explained below.

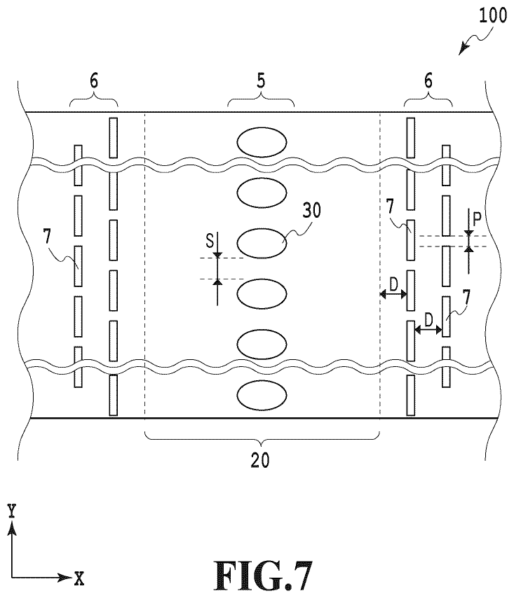

FIG. 7 is a diagram illustrating part of the ejection port array 5 and the stress disrupting grooves 6 of the liquid ejection head substrate 100 in the present embodiment. In the present embodiment, the configuration is such that two arrays of the stress disrupting grooves 6 explained in the first embodiment are provided (multiple arrays are provided) on each side of the ejection port arrays 5. Since one array of the stress disrupting groove 6 is provided in the first embodiment, there are the portions with grooves and the portions without grooves in the Y direction, and the stress disruption effect sometimes varies between the portions with grooves and the portions without grooves.

In the present embodiment, the two arrays of stress disrupting grooves 6 are arranged in a zigzag form such that the portions with grooves and the portions without grooves are not formed in the Y direction. Since this eliminates the portions without grooves in the Y direction, a desired stress disruption effect is obtained, and no deformation of the ejection ports is observed. Note that the distance S, the distance D, and the distance P are the same as those in the first embodiment, and the width of the groove portions 7 in the X direction is the same as that in the first embodiment, and is preferably as small as possible as long as processing is possible to hinder entrance of the liquid. A high-quality ejection characteristic is confirmed as a result of performing printing with a liquid ejection head completed as descried above. Note that, although the two arrays of stress disrupting grooves 6 are provided in the present embodiment, multiple arrays of stress disrupting grooves 6 may be provided.

### Fourth Embodiment

A fourth embodiment of the present disclosure is exampled below with reference to the drawings. Note that, since a basic configuration of the present embodiment is the same as that of the first embodiment, characteristic configurations are explained below.

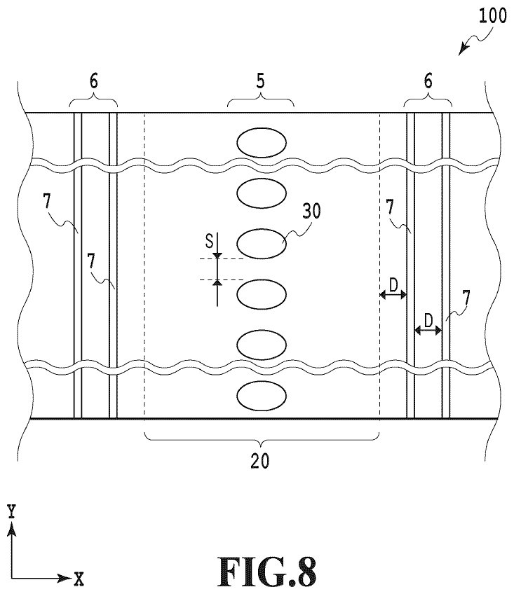

FIG. 8 is a diagram illustrating part of the ejection port array 5 and the stress disrupting grooves 6 of the liquid ejection head substrate 100 in the present embodiment. In the present embodiment, the configuration is such that two arrays of the groove portions 7 explained in the second embodiment are provided on each side of the ejection port array 5. In the groove portions 7 explained in the second embodiment, the portions without grooves are eliminated in the Y direction, and the desired stress disruption effect is thereby obtained. However, providing two arrays of the groove portions 7 as in the present embodiment increases portions where warping caused by the stress is absorbed, and suppression of deformation of the ejection ports 30 can be expected.

As in the second embodiment, the groove portions 7 desirably extend over at least a length equal to or more than the length over which the ejection port arrays 5 extend. The width of the groove portions 7 in the X direction is the same as that in the first embodiment, and is preferably as small as possible as long as processing is possible to hinder entrance of the liquid. Note that the distance S and the distance D are the same as those in the first embodiment. A high-quality ejection characteristic is confirmed as a result of performing printing with a liquid ejection head completed as described above. Note that, although the two arrays of groove portions 7 are provided in the present embodiment, multiple arrays of groove portions 7 may be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-222371, filed Dec. 18, 2024, which is hereby incorporated by reference herein in its entirety.

What is claimed is:

1. A liquid ejection head comprising:
a liquid flow passage through which a liquid is capable of flowing;
a plurality of ejection ports communicating with the liquid flow passage and capable of ejecting the liquid;
an ejection port array in which the plurality of ejection ports are aligned;
a plurality of energy generation elements provided to be opposed to the ejection ports and configured to generate energy for ejecting the liquid in the liquid flow passage from the ejection ports; and
a substrate provided with the energy generation elements, wherein
a flow passage wall-forming layer in which the liquid flow passage is formed is formed on the substrate,
an ejection port-forming layer in which the ejection port array is formed is formed on the flow passage wall-forming layer, and
a liquid ejection head includes a groove that is provided in the ejection port-forming layer along the ejection port array and that has a bottom portion formed of the ejection port-forming layer or the flow passage wall-forming layer.

2. The liquid ejection head according to claim 1, wherein the groove is provided to penetrate the ejection port-forming layer.

3. The liquid ejection head according to claim 1, wherein the groove is a groove portion array in which a plurality of groove portions are aligned along the ejection port array.

4. The liquid ejection head according to claim 3, wherein a plurality of the groove portion arrays are provided on each side of the ejection port array.

5. The liquid ejection head according to claim 4, wherein the groove portions are arranged in a zigzag form in the plurality of groove portion arrays.

6. The liquid ejection head according to claim 3, wherein an interval of the groove portions adjacent to each other in the groove portion array is 10 μm or less.

7. The liquid ejection head according to claim 1, wherein the groove is a continuous groove extending along the ejection port array.

8. The liquid ejection head according to claim 7, wherein a plurality of the continuous grooves are provided on each side of the ejection port array.

9. The liquid ejection head according to claim 1, wherein a distance from a wall of the liquid flow passage having a face including an ejection direction on one side of the ejection port array to a wall of the groove having a face including the ejection direction on a side close to the ejection ports in a first direction orthogonal to the ejection port array in the same plane as the ejection port array is 20 μm or less.

10. The liquid ejection head according to claim 9, wherein a width h of the groove in the first direction is within a range of h=H/2 to 5H, where H is a thickness of the ejection port-forming layer.

11. The liquid ejection head according to claim 1, wherein an interval of the ejection ports adjacent to each other in the ejection port array is 25 μm or less.

12. The liquid ejection head according to claim 1, wherein an interval of the ejection ports adjacent to each other in the ejection port array is 10 μm or less.

13. The liquid ejection head according to claim 1, wherein the ejection port-forming layer and the flow passage wall-forming layer are a negative photosensitive resin.

14. The liquid ejection head according to claim 10, wherein the width h of the groove in the first direction is within a range of 3 μm to 25 μm.

15. A liquid ejection head substrate comprising:
a liquid flow passage through which a liquid is capable of flowing;
a plurality of ejection ports communicating with the liquid flow passage and capable of ejecting the liquid;
an ejection port array in which the plurality of ejection ports are aligned;
a plurality of energy generation elements provided to be opposed to the ejection ports and configured to generate energy for ejecting the liquid in the liquid flow passage from the ejection ports; and
a substrate provided with the energy generation elements, wherein
a flow passage wall-forming layer in which the liquid flow passage is formed is formed on the substrate,
an ejection port-forming layer in which the ejection port array is formed is formed on the flow passage wall-forming layer, and
the liquid ejection head substrate includes a groove that is provided in the ejection port-forming layer along the ejection port array and that has a bottom portion formed of the ejection port-forming layer or the flow passage wall-forming layer.

16. A manufacturing method of a liquid ejection head including a liquid flow passage through which a liquid is capable of flowing, a plurality of ejection ports communicating with the liquid flow passage and capable of ejecting the liquid, an ejection port array in which the plurality of ejection ports are aligned, a plurality of energy generation elements provided to be opposed to the ejection ports and configured to generate energy for ejecting the liquid in the liquid flow passage from the ejection ports, and a substrate provided with the energy generation elements, the manufacturing method comprising:
forming a flow passage wall-forming layer in which the liquid flow passage is formed, on the substrate;
forming an ejection port-forming layer in which the ejection port array is formed, on the flow passage wall-forming layer; and
forming a groove having the ejection port-forming layer or the flow passage wall-forming layer as a bottom portion, in the ejection port-forming layer along the ejection port array.

17. The manufacturing method of the liquid ejection head according to claim 16, wherein formation of the ejection ports and formation of the groove are simultaneously performed.
